(19) United States
(12) Patent Application Publication
(10) Pub. No.: US 2008/0000033 A1
(43) Pub. Date: Jan. 3, 2008

(54) Composition for Dyeing Human Keratin Fibres, Comprising a 1H-Pyrazolyl-Ethenyl-Indolium Derivative

(76) Inventor: Andrew Greaves, Montevrain (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/567,164

(22) PCT Filed: Aug. 2, 2004
(86) PCT No.: PCT/EP04/09161

§ 371 Date: Jan. 10, 2007

Related U.S. Application Data
(60) Provisional application No. 60/506,514, filed on Sep. 29, 2003.

(30) Foreign Application Priority Data
Aug. 5, 2003 (FR) 03/09659

(51) Int. Cl. A61Q 5/10

(52) U.S. Cl. 8/407; 8/406

(57) ABSTRACT

The present invention relates to a dye composition comprising, in a suitable cosmetic medium, a 1H-pyrazolyl-ethenyl-indolium derivative of formula (I) below:

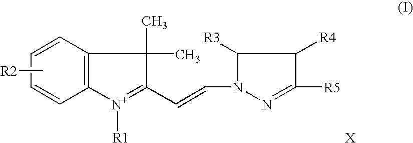

in which
R1 represents a linear or branched C1-C4 alkyl radical or a C1-C4 aralkyl radical, R2 represents a hydrogen atom, a C1-C4 alkyl radical, a C1-C4 alkoxy radical, a halogen atom or a nitro group; R3 and R4, which may be identical or different, represent a hydrogen atom, a C1-C4 alkyl radical, an aryl radical which may be substituted with one radical R chosen from a halogen atom, a hydroxyl radical, a C1-C4 alkyl radical, a C1-C4 alkoxy radical, a carboxyl radical and a trifluoromethyl radical, R5 represents a hydrogen atom, a C1-C4 alkyl radical or an aryl radical that may be substituted with one radical R, and X is a counterion.

Such a composition makes it possible to obtain direct colourations that are particularly resistant to external agents, in particular to shampoo.

The invention relates to a composition for dyeing human keratin fibres, comprising, in a suitable medium, a 1H-pyrazolyl-ethenyl-indolium derivative, and also to the dyeing process using this composition.

It is known practice to dye keratin fibres, and in particular human hair, with dye compositions containing oxidation dye precursors, which are generally known as oxidation bases, such as ortho- or para-phenylenediamines, ortho- or para-aminophenols and heterocyclic compounds. These oxidation bases are colourless or weakly coloured compounds, which, when combined with oxidizing products, may give rise to coloured compounds via a process of oxidative condensation. It is also known that the shades obtained may be varied by combining these oxidation bases with couplers or coloration modifiers, the latter being chosen especially from aromatic meta-diamines, meta-aminophenols, meta-diphenols and certain heterocyclic compounds such as indole compounds. The oxidation dyeing process consists in applying to the keratin fibres bases or a mixture of bases and couplers with aqueous hydrogen peroxide solution as oxidizing agent, leaving the mixture to act and then rinsing the fibres.

The variety of molecules used as oxidation bases and couplers allows a wide range of colours to be obtained.

The colorations resulting therefrom are permanent, strong and resistant to external agents, especially to light, bad weather, washing, perspiration and rubbing. However, oxidation dyeing requires the use of an oxidizing agent and also pH conditions which are such that the keratin fibres thus treated are often impaired after one or more dyeing operations.

It is also known practice to dye human keratin fibres, and in particular the hair, by direct dyeing. The process conventionally used in direct dyeing consists in applying to the keratin fibres direct dyes, which are coloured and colouring molecules that have affinity for the fibres, leaving the mixture to act and then rinsing the fibres.

The direct dyes that are generally used are dyes of the nitrobenzene type, anthraquinone dyes, nitropyridines or dyes of the azo, xanthene, acridine, azine or triarylmethane type.

Although this type of dyeing respects the integrity of the keratin fibre, the colorations obtained using these direct dyes are temporary or semi-permanent since the nature of the interactions that bind the direct dyes to the keratin fibre, and their desorption from the surface and/or from the core of the fibre are responsible for their weak dyeing power and their poor fastness with respect to washing or perspiration.

The aim of the present invention is to provide novel compositions for the direct dyeing of human keratin fibres, which do not have the drawbacks of the compositions of the prior art. In particular, the aim of the invention is to provide novel compositions for dyeing human keratin fibres, which show strong affinity for these keratin fibres, in particular the hair, in order to increase the resistance of the coloration to external agents, such as resistance to shampooing, to light or to sweat, while at the same time respecting the integrity of the keratin fibres.

This aim is achieved with the present invention, one subject of which is a dye composition comprising, in a suitable cosmetic medium, a 1H-pyrazolyl-ethenyl-indolium derivative of formula (I) below:

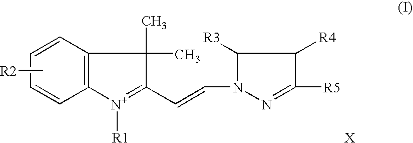

in which
R1 represents a linear or branched C1-C4 alkyl radical or a C1-C4 aralkyl radical,
R2 represents a hydrogen atom, a C1-C4 alkyl radical, a C1-C4 alkoxy radical, a halogen atom or a nitro group;
R3 and R4, which may be identical or different, represent a hydrogen atom, a C1-C4 alkyl radical, an aryl radical which may be substituted with one or more radicals R chosen from a halogen atom, a hydroxyl radical, a C1-C4 alkyl radical, a C1-C4 alkoxy radical, a carboxyl radical and a trifluoromethyl radical,
R5 represents a hydrogen atom, a C1-C4 alkyl radical or an aryl radical that may be substituted with one or more radicals R, and
X is a counterion, for example a chloride, bromide or methyl sulfate ion.

A subject of the invention is also a dyeing process using this composition.

Another subject of the invention is the use of the 1H-pyrazolyl-ethenyl-indolium derivative of formula (I) for dyeing human keratin fibres such as the hair.

Such a composition makes it possible to obtain direct colourations that are particularly resistant to external agents, in particular to shampoo.

In formula (I) above, R1 may be a linear or branched methyl, ethyl, propyl, butyl or pentyl radical, or a benzyl radical. R1 preferably represents a C1-C4 alkyl radical.

R2 may represent a hydrogen atom, a linear or branched methyl, ethyl or propyl radical, a methoxy, ethoxy or propyloxy radical, a chlorine or bromine atom, or a nitro radical. R2 preferably represents a hydrogen atom or an alkyl or alkoxy radical, in particular a hydrogen atom or a methyl or methoxy radical.

By way of example for R3 and R4, mention may be made of a hydrogen atom, a methyl, ethyl, propyl or butyl radical, or a phenyl radical, which may be substituted. Preferably, R3 and R4 independently represent a hydrogen atom or an alkyl or phenyl radical. According to one particular embodiment, R3 represents a hydrogen atom, a methyl radical or a phenyl radical, which may be substituted with one or more hydroxyl, alkoxy, methyl or chloro radicals and R4 represents a hydrogen atom or a phenyl radical, which may be substituted with one or more hydroxyl, alkoxy, methyl or chloro radicals.

In formula (I), R5 may be a hydrogen atom, a methyl, ethyl, propyl or butyl radical, or a phenyl radical, which may be substituted. According to one particular embodiment, R5 represents a hydrogen atom or an alkyl or phenyl radical. Preferably, R5 represents a hydrogen atom, a methyl radical or a phenyl radical, which may be substituted with one or more hydroxyl, alkoxy, methyl or chloro radicals.

By way of example, mention may be made of the derivatives of formula (I) below:

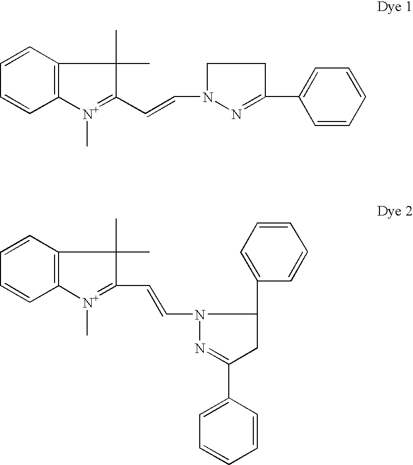

According to one particularly preferred embodiment, R1 represents a methyl radical, R2 represents a hydrogen atom, R4 represents a methyl radical and, when R5 represents 4-hydroxyphenyl, then R3 represents a methyl radical, when R5 represents a 4-methoxyphenyl radical, then R3 represents a hydrogen atom, when R5 represents a 2-hydroxyphenyl radical, then R3 represents a phenyl radical, or when R5 represents a 4-chlorophenyl radical, then R3 represents a 2-hydroxyphenyl radical.

The composition of the present invention generally comprises between 0.01% and 20% by weight of 1H-pyrazolyl-ethenyl-indolium derivatives and preferably between 0.1% and 5% relative to the total weight of the composition.

The 1H-pyrazolyl-ethenyl-indolium derivatives that are useful for the present invention may be synthesized via methods that are well known to those skilled in the art, in particular the methods described in documents DE 2 345 462 and GB 1 301 492.

The composition of the present invention may contain one or more other dyes, for example direct dyes, oxidation bases or couplers.

The direct dyes may be chosen especially from nitrobenzene dyes, azo direct dyes and methine direct dyes. These direct dyes may be of nonionic, anionic or cationic nature. The direct dyes that may be used according to the invention are preferably chosen from neutral, acidic or cationic nitrobenzene direct dyes, neutral, acidic or cationic azo direct dyes, quinone direct dyes and in particular neutral, acidic or cationic anthraquinones, azine direct dyes, triarylmethane direct dyes, indoamine direct dyes and natural direct dyes.

Among the nitrobenzene dyes that may be mentioned are the following red or orange compounds: 1-hydroxy-3-nitro-4-N-(γ-hydroxypropyl)aminobenzene, N-(β-hydroxyethyl)amino-3-nitro-4-aminobenzene, 1-amino-3-methyl-4-N-(β-hydroxyethyl)amino-6-nitrobenzene, 1-hydroxy-3-nitro-4-N-(β-hydroxyethyl)-aminobenzene, 1,4-diamino-2-nitrobenzene, 1-amino-2-nitro-4-methylaminobenzene, N-(β-hydroxyethyl)-2-nitroparaphenylenediamine, 1-amino-2-nitro-4-(β-hydroxyethyl)amino-5-chlorobenzene, 2-nitro-4-aminodiphenylamine, 1-amino-3-nitro-6-hydroxybenzene, 1-(β-aminoethyl)amino-2-nitro-4-(β-hydroxyethyloxy)-benzene, 1-(β,γ-dihydroxypropyl)oxy-3-nitro-4-(β-hydroxyethyl)aminobenzene, 1-hydroxy-3-nitro-4-aminobenzene, 1-hydroxy-2-amino-4,6-dinitrobenzene, 1-methoxy-3-nitro-4-(β-hydroxyethyl)aminobenzene, 2-nitro-4′-hydroxydiphenylamine, 1-amino-2-nitro-4-hydroxy-5-methylbenzene, alone or as mixtures.

As regards the nitrobenzene direct dyes, use may be made of dyes of yellow and green-yellow type, for instance 1-β-hydroxyethyloxy-3-methylamino-4-nitrobenzene, 1-methylamino-2-nitro-5-(β,γ-dihydroxy-propyl)oxybenzene, 1-(β-hydroxyethyl)amino-2-methoxy-4-nitrobenzene, 1-(β-aminoethyl)amino-2-nitro-5-methoxybenzene, 1,3-bis(β-hydroxyethyl)amino-4-nitro-6-chlorobenzene, 1-amino-2-nitro-6-methylbenzene, 1-(β-hydroxyethyl)amino-2-hydroxy-4-nitrobenzene, N-(β-hydroxyethyl)-2-nitro-4-trifluoromethylaniline, 4-(β-hydroxyethyl)amino-3-nitrobenzenesulphonic acid, 4-ethylamino-3-nitrobenzoic acid, 4-β-hydroxyethyl)-amino-3-nitrochlorobenzene, 4-(β-hydroxyethyl)amino-3-nitromethylbenzene, 4-(β,γ-dihydroxypropyl)amino-3-nitrotrifluoromethylbenzene, 1-(β-ureidoethyl)amino-4-nitrobenzene, 1,3-diamino-4-nitrobenzene, 1-hydroxy-2-amino-5-nitrobenzene, 1-amino-2-[tris(hydroxymethyl)-methyl]amino-5-nitrobenzene, 1-(β-hydroxyethyl)amino-2-nitrobenzene and 4-(β-hydroxyethyl)amino-3-nitrobenzamide.

It may also be envisaged to use blue or violet nitrobenzene dyes, for instance, inter alia, 1-(β-hydroxyethyl)amino-4-N,N-bis(β-hydroxyethyl)amino-2-nitrobenzene, 1-(γ-hydroxypropyl)amino-4-N,N-bis-(β-hydroxyethyl)amino-2-nitrobenzene, 1-(β-hydroxy-ethyl)amino-4-(N-methyl, N-β-hydroxyethyl)amino-2-nitrobenzene, 1-(β-hydroxyethyl)amino-4-(N-ethyl, N-β-hydroxyethyl)amino-2-nitrobenzene, 1-(β,γ-dihydroxy-propyl)amino-4-(N-ethyl, N-β-hydroxyethyl)amino-2-nitrobenzene, the 2-nitro-para-phenylenediamines of the following formula:

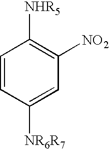

in which:
R₆ represents a C₁-C₄ alkyl radical or a β-hydroxyethyl, β-hydroxypropyl or γ-hydroxypropyl radical;
R₅ and R₇, which may be identical or different, represent a β-hydroxyethyl, β-hydroxypropyl, γ-hydroxypropyl or β,γ-dihydroxypropyl radical, at least one of the radicals R₆, R₇ or R₅ representing a γ-hydroxypropyl radical and R₆ and R₇ not being able simultaneously to denote a β-hydroxyethyl radical when R₆ is a γ-hydroxypropyl radical, such as those described in French patent FR 2 692 572.

It is recalled that azo dyes are compounds comprising in their structure at least one —N═N— sequence not included in a ring; methine dyes are compounds comprising in their structure at least one —C═C— sequence not included in a ring; azomethine dyes are compounds comprising in their structure at least one —C═N— sequence not included in a ring.

The triarylmethane-based dyes comprise in their structure at least one sequence below:

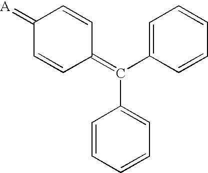

### A denoting an oxygen or nitrogen atom.

The xanthene dyes comprise in their structure at least one sequence of formula:

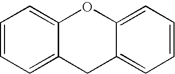

The phenanthridine dyes comprise in their structure at least one sequence of formula:

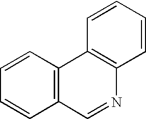

The phthalocyanin dyes comprise in their structure at least one sequence of formula:

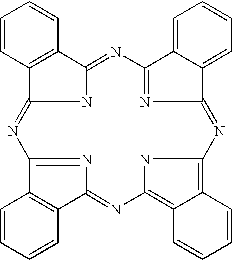

The phenothiazine dyes comprise in their structure at least one sequence below:

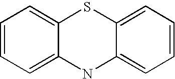

The direct dyes may moreover be chosen from basic dyes like those listed in the Color Index, 3rd edition, especially under the names “Basic Brown 16”, “Basic Brown 17”, “Basic Yellow 57”, “Basic Red 76”, “Basic Violet 10”, “Basic Blue 26” and “Basic Blue 99”; or from the acidic direct dyes listed in the Color Index, 3rd edition, under the names “Acid Orange 7”, “Acid Orange 24”, “Acid Yellow 36”, “Acid Red 33”, “Acid Red 184”, “Acid Black 2”, “Acid Violet 43”, and “Acid Blue 62”, or cationic direct dyes such as those described in patent applications WO 95/01772, WO 95/15144 and EP 714 954, the content of which forms an integral part of the present invention.

When they are present, the direct dye(s) preferably represent(s) from 0.0005% to 12% by weight approximately relative to the total weight of the composition and even more preferably from 0.005% to 6% by weight approximately relative to this weight.

The oxidation bases that may be used in the composition of the present invention are the oxidation bases conventionally used in oxidation dyeing. By way of example, these oxidation bases are chosen from, for example para-phenylenediamines, bis(phenyl)alkylenediamines, para-aminophenols, bis-para-aminophenols, ortho-aminophenols and heterocyclic bases, and the addition salts thereof.

Among the para-phenylenediamines that may more particularly be mentioned, are para-phenylenediamine, para-tolylenediamine, 2-chloro-para-phenylenediamine, 2,3-dimethyl-para-phenylenediamine, 2,6-dimethyl-para-phenylenediamine, 2,6-diethyl-para-phenylenediamine, 2,5-dimethyl-para-phenylenediamine, N,N-dimethyl-para-phenylenediamine, N,N-diethyl-para-phenylenediamine, N,N-dipropyl-para-phenylenediamine, N,N-diethylamino-3-methyl-para-phenylenediamine, N,N-bis(β-hydroxyethyl)-para-phenylenediamine, 4N,N-bis(β-hydroxyethyl)amino-2-methylaniline, N,N-bis(β-hydroxy-ethyl)amino-2-chloro-para-phenylenediamine, 2-β-hydroxyethyl-para-phenylenediamine, 2-fluoro-para-phenylenediamine, 2-isopropyl-para-phenylenediamine, N-(β-hydroxypropyl)-para-phenylenediamine, 2-hydroxymethyl-para-phenylenediamine, N,N-dimethyl-3-methyl-para-phenylenediamine, N-ethyl-N-(β-hydroxy-ethyl)-para-phenylenediamine, N-(β,γ-dihydroxypropyl)-para-phenylenediamine, N-(4′-aminophenyl)-para-phenylenediamine, N-phenyl-para-phenylenediamine, 2-β-hydroxyethyloxy-para-phenylenediamine, 2-β-acetyl-aminoethyloxy-para-phenylenediamine and N-(β-methoxy-ethyl)-para-phenylenediamine, and the addition salts thereof with an acid.

Among the para-phenylenediamines mentioned above, para-phenylenediamine, para-tolylenediamine, 2-isopropyl-para-phenylenediamine, 2-β-hydroxyethyl-para-phenylenediamine, 2-β-hydroxyethyloxy-para-phenylenediamine, 2,6-dimethyl-para-phenylenediamine, 2,6-diethyl-para-phenylenediamine, 2,3-dimethyl-para-phenylenediamine, N,N-bis(β-hydroxyethyl)-para-phenylenediamine, 2-chloro-para-phenylenediamine and 2-β-acetylaminoethyloxy-para-phenylenediamine, and the addition salts thereof with an acid, are very particularly preferred.

Among the bis(phenyl)alkylenediamines that may more particularly be mentioned, for example, are N,N′-bis(β-hydroxyethyl)-N,N′-bis(4′-aminophenyl)-1,3-diaminopropanol, N,N′-bis(β-hydroxyethyl)-N,N′-bis(4′-aminophenyl)ethylenediamine, N,N′-bis(4-aminophenyl)tetramethylenediamine, N,N′-bis(β-hydroxyethyl)-N,N′-bis(4-amino-phenyl)tetramethylenediamine, N,N′-bis(4-methylamino-phenyl)tetramethylenediamine, N,N′-bis(ethyl)-N,N′-bis-(4′-amino-3′-methylphenyl)ethylenediamine and 1,8-bis-(2,5-diaminophenoxy)-3,5-dioxaoctane, and the addition salts thereof with an acid.

Among the para-aminophenols that may more particularly be mentioned, for example, are para-aminophenol, 4-amino-3-methylphenol, 4-amino-3-fluorophenol, 4-amino-3-hydroxymethylphenol, 4-amino-2-methylphenol, 4-amino-2-hydroxymethylphenol, 4-amino-2-methoxymethylphenol, 4-amino-2-aminomethylphenol, 4-amino-2-(β-hydroxyethylaminomethyl)phenol and 4-amino-2-fluorophenol, and the addition salts thereof with an acid.

Among the ortho-aminophenols that may more particularly be mentioned, for example, are 2-aminophenol, 2-amino-5-methylphenol, 2-amino-6-methylphenol and 5-acetamido-2-aminophenol, and the addition salts thereof with an acid.

Among the heterocyclic bases that may more particularly be mentioned, for example, are pyridine derivatives, pyrimidine derivatives and pyrazole derivatives.

Among the pyridine derivatives that may more particularly be mentioned are the compounds described, for example, in patents GB 1 026 978 and GB 1 153 196, such as 2,5-diaminopyridine, 2-(4-methoxyphenyl)amino-3-aminopyridine, 2,3-diamino-6-methoxypyridine, 2-(β-methoxyethyl)amino-3-amino-6-methoxypyridine and 3,4-diaminopyridine, and the addition salts thereof with an acid.

Among the pyrimidine derivatives that may more particularly be mentioned are the compounds described, for example, in patents DE 2 359 399; JP 88-169 571; JP 05-163 124; EP 0 770 375 or patent application WO 96/15765, such as 2,4,5,6-tetraaminopyrimidine, 4-hydroxy-2,5,6-triamino-pyrimidine, 2-hydroxy-4,5,6-triaminopyrimidine, 2,4-dihydroxy-5,6-diaminopyrimidine and 2,5,6-triamino-pyrimidine, and pyrazolopyrimidine derivatives such as those mentioned in patent application FR-A-2 750 048 and among which mention may be made of pyrazolo[1,5-a]-pyrimidine-3,7-diamine; 2,5-dimethylpyrazolo[1,5-a]-pyrimidine-3,7-diamine; pyrazolo[1,5-a]pyrimidine-3,5-diamine; 2,7-dimethylpyrazolo[1,5-a]pyrimidine-3,5-diamine; 3-aminopyrazolo[1,5-a]pyrimidin-7-ol; 3-aminopyrazolo[1,5-a]pyrimidin-5-ol; 2-(3-amino-pyrazolo[1,5-a]pyrimidin-7-ylamino)ethanol, 2-(7-amino-pyrazolo[1,5-a]pyrimidin-3-ylamino)ethanol, 2-[(3-aminopyrazolo[1,5-a]pyrimidin-7-yl)(2-hydroxy-ethyl)amino]ethanol, 2-[(7-aminopyrazolo[1,5-a]-pyrimidin-3-yl)(2-hydroxyethyl)amino]ethanol, 5,6-dimethylpyrazolo[1,5-a]pyrimidine-3,7-diamine, 2,6-dimethylpyrazolo[1,5-a]pyrimidine-3,7-diamine, 2,5,N7,N7-tetramethylpyrazolo[1,5-a]pyrimidine-3,7-diamine and 3-amino-5-methyl-7-imidazolylpropyl-aminopyrazolo[1,5-a]pyrimidine, and the addition salts thereof with an acid and the tautomeric forms thereof, when a tautomeric equilibrium exists.

Among the pyrazole derivatives that may more particularly be mentioned are the compounds described in patents DE 3 843 892 and DE 4 133 957 and patent applications WO 94/08969, WO 94/08970, FR-A-2 733 749 and DE 195 43 988, such as 4,5-diamino-1-methylpyrazole, 4,5-diamino-1-(β-hydroxyethyl)pyrazole, 3,4-diaminopyrazole, 4,5-diamino-1-(4′-chlorobenzyl)pyrazole, 4,5-diamino-1,3-dimethylpyrazole, 4,5-diamino-3-methyl-1-phenylpyrazole, 4,5-diamino-1-methyl-3-phenylpyrazole, 4-amino-1,3-dimethyl-5-hydrazinopyrazole, 1-benzyl-4,5-diamino-3-methylpyrazole, 4,5-diamino-3-tert-butyl-1-methylpyrazole, 4,5-diamino-1-tert-butyl-3-methylpyrazole, 4,5-diamino-1-(β-hydroxyethyl)-3-methylpyrazole, 4,5-diamino-1-ethyl-3-methylpyrazole, 4,5-diamino-1-ethyl-3-(4′-methoxyphenyl)pyrazole, 4,5-diamino-1-ethyl-3-hydroxymethylpyrazole, 4,5-diamino-3-hydroxymethyl-1-methylpyrazole, 4,5-diamino-3-hydroxymethyl-1-isopropylpyrazole, 4,5-diamino-3-methyl-1-isopropylpyrazole, 4-amino-5-(2′-aminoethyl)amino-1,3-dimethylpyrazole, 3,4,5-triaminopyrazole, 1-methyl-3,4,5-triamino-pyrazole, 3,5-diamino-1-methyl-4-methylaminopyrazole and 3,5-diamino-4-(β-hydroxyethyl)amino-1-methyl-pyrazole, and the addition salts thereof with an acid.

When they are used, these oxidation bases preferably represent from 0.0005% to 12% by weight approximately relative to the total weight of the dye composition, and even more preferably from 0.005% to 6% by weight approximately relative to this weight.

The couplers may be chosen from the couplers conventionally used in oxidation dyeing, and among which mention may be made especially of meta-phenylenediamines, meta-aminophenols, meta-diphenols, naphthols and heterocyclic couplers, for instance indole derivatives, indoline derivatives, pyridine derivatives, indazole derivatives, pyrazolo[1,5-b]-1,2,4-triazole derivatives, pyrazolo[3,2-c]-1,2,4-triazole derivatives, benzimidazole derivatives, benzothiazole derivatives, benzoxazole derivatives, 1,3-benzodioxole derivatives and pyrazolones, and the addition salts thereof with an acid.

These couplers are more particularly chosen from 2-methyl-5-aminophenol, 5-N-(β-hydroxyethyl)amino-2-methylphenol, 3-aminophenol, 1,3-dihydroxybenzene, 1,3-dihydroxy-2-methylbenzene, 4-chloro-1,3-dihydroxy-benzene, 2,4-diamino-1-(β-hydroxyethyloxy)benzene, 2-amino-4-(β-hydroxyethylamino)-1-methoxybenzene, 1,3-diaminobenzene, 1,3-bis(2,4-diaminophenoxy)propane, sesamol, α-naphthol, 2-methyl-1-naphthol, 6-hydroxyindole, 4-hydroxyindole, 4-hydroxy-N-methylindole, 6-hydroxyindoline, 6-hydroxybenzomorpholine, 3,5-diamino-2,6-dimethoxy-pyridine, 1-N(β-hydroxyethyl)amino-3,4-methylenedioxy-benzene, 2,6-bis(β-hydroxyethyleneamino)toluene, 2,6-dihydroxy-4-methylpyridine, 1H-3-methylpyrazol-5-one, 1-phenyl-3-methylpyrazol-5-one, and the addition salts thereof with an acid.

When they are used, the coupler(s) preferably represent(s) from 0.0001% to 10% by weight approximately relative to the total weight of the dye composition, and even more preferably from 0.005% to 5% by weight approximately relative to this weight.

The medium that is suitable for dyeing, also known as the dye support, is generally a cosmetic medium consisting of water or of a mixture of water and of at least one organic solvent to dissolve the compounds that would not be sufficiently water-soluble. Examples of organic solvents that may be mentioned include C₁-C₄ lower alkanols, such as ethanol and isopropanol; polyols and polyol ethers, for instance 2-butoxyethanol, propylene glycol, propylene glycol monomethyl ether, diethylene glycol monoethyl ether and monomethyl ether, and also aromatic alcohols, for instance benzyl alcohol or phenoxyethanol, and mixtures thereof.

The solvents are preferably present in proportions preferably of between 1% and 40% by weight approximately relative to the total weight of the dye composition, and even more preferably between 5% and 30% by weight approximately.

The dye composition in accordance with the invention may also contain various adjuvants conventionally used in compositions for dyeing the hair, such as anionic, cationic, nonionic, amphoteric or zwitterionic surfactants, or mixtures thereof.

By way of example of anionic surfactants that can be used, alone or as mixtures, mention may be made in particular of salts (in particular alkali metal salts, especially sodium salts, ammonium salts, amine salts, amino alcohol salts or magnesium salts) of the following compounds: alkyl sulphates, alkyl ether sulphates, alkylamido ether sulphates, alkylarylpolyether sulphates, monoglyceride sulphates; alkyl sulphonates, alkyl phosphates, alkylamide sulphonates, alkylaryl sulphonates, α-olefin sulphonates, paraffin sulphonates; (C₆-C₂₄)alkyl sulphosuccinates, (C₆-C₂₄)alkyl ether sulphosuccinates, (C₆-C₂₄)alkylamide sulphosuccinates; (C₆-C₂₄)alkyl sulphoacetates; (C₆-C₂₄)acyl sarcosinates and (C₆-C₂₄)acyl glutamates. It is also possible to use (C₆-C₂₄)alkylpolyglycoside carboxylic esters such as alkylglucoside citrates, alkylpolyglycoside tartrates and alkylpolyglycoside sulphosuccinates, alkylsulpho-succinamates; acyl isethionates and N-acyl taurates, the alkyl or acyl radical of all of these different compounds preferably containing from 12 to 20 carbon atoms and the aryl radical preferably denoting a phenyl or benzyl group. Among the anionic surfactants which can also be used, mention may also be made of fatty acid salts such as oleic, ricinoleic, palmitic and stearic acid salts, coconut oil acids or hydrogenated coconut oil acid; acyl lactylates in which the acyl radical contains more particularly 8 to 20 carbon atoms. It is also possible to use alkyl D-galactoside uronic acids and their salts, polyoxyalkylenated (C₆-C₂₄)alkyl ether carboxylic acids, polyoxyalkylenated (C₆-C₂₄)alkylaryl ether carboxylic acids, polyoxyalkylenated (C₆-C₂₄)alkylamido ether carboxylic acids and their salts, in particular those containing from 2 to 50 alkylene oxide groups, in particular ethylene oxide groups, and mixtures thereof. The nonionic surfactants are, themselves also, compounds that are well known per se (see in particular in this respect “Handbook of Surfactants” by M. R. Porter, published by Blackie & Son (Glasgow and London), 1991, pp. 116-178). They can be chosen in particular from polyethoxylated and/or polypropoxylated, alkylphenols, alpha-diols or alcohols, having a fatty chain containing, for example, 8 to 18 carbon atoms, it being possible for the number of ethylene oxide and/or propylene oxide groups to range in particular from 2 to 50. Mention may also be made of copolymers of ethylene oxide and of propylene oxide, condensates of ethylene oxide and of propylene oxide with fatty alcohols; polyethoxylated fatty amides preferably having from 2 to 30 mol of ethylene oxide, polyglycerolated fatty amides containing on average 1 to 5, and in particular 1.5 to 4, glycerol groups; polyethoxylated fatty amines preferably having 2 to 30 mol of ethylene oxide; oxyethylenated fatty acid esters of sorbitan having from 2 to 30 mol of ethylene oxide; fatty acid esters of sucrose, fatty acid esters of polyethylene glycol, alkylpolyglycosides, N-alkylglucamine derivatives, and amine oxides such as (C₁₀-C₁₄)alkylamine oxides or N-acylaminopropylmorpholine oxides.

The amphoteric or zwitterionic surfactants can be, in particular chosen from aliphatic secondary or tertiary amine derivatives in which the aliphatic radical is a linear or branched chain containing 8 to 18 carbon atoms and containing at least one water-solubilizing anionic group (for example carboxylate, sulphonate, sulphate, phosphate or phosphonate); mention may also be made of (C₈-C₂₀)alkylbetaines, sulphobetaines, (C₈-C₂₀) alkylamido (C₁-C₆) alkylbetaines or (C₈-C₂₀) alkylamido (C₁-C₆) alkylsulphobetaines.

Among the amine derivatives, mention may be made of the products sold under the name Miranol, as described in U.S. Pat. Nos. 2,528,378 and 2,781,354 and classified in the CTFA dictionary, 3rd edition, 1982, under the names Amphocarboxyglycinates and Amphocarboxypropionates, with the respective structures:
R₂—CONHCH₂CH₂—N(R₃) (R₄) (CH₂COO⁻)
in which: R₂ denotes an alkyl radical of an acid R₂—COOH present in hydrolysed coconut oil, a heptyl, nonyl or undecyl radical, R₃ denotes a beta-hydroxyethyl group and R₄ denotes a carboxymethyl group; and
R₂′ —CONHCH₂CH₂—N(B) (C)
in which:
B represents —CH₂CH₂OX′, C represents —(CH₂)_{z}—Y′, with z=1 or 2,
X′ denotes the —CH₂CH₂—COOH group or a hydrogen atom,
Y′ denotes —COOH or the —CH₂—CHOH—SO₃H radical,
R₂′ denotes an alkyl radical of an acid R₉—COOH present in coconut oil or in hydrolysed linseed oil, an alkyl radical, in particular a C₇, C₉, C₁₁ or C₁₃ alkyl radical, a C₁₇ alkyl radical and its iso form, or an unsaturated C₁₇ radical.

These compounds are classified in the CTFA dictionary, 5th edition, 1993, under the names Disodium Cocoamphodiacetate, Disodium Lauroamphodiacetate, Disodium Caprylamphodiacetate, Disodium Capryloamphodiacetate, Disodium Cocoamphodipropionate, Disodium Lauroamphopropionate, Disodium Caprylamphodipropionate, Disodium Caprylamphodipropionate, Lauroamphodipropionic acid and Cocoamphodipropionic acid.

By way of example, mention may be made of the cocoamphodiacetate sold under the trade name Miranol C2M concentrate by the company Rhodia Chimie.

Among the cationic surfactants, mention may be made in particular of: salts of optionally polyoxyalkylenated primary, secondary or tertiary fatty amines; quaternary ammonium salts such as tetraalkylammonium, alkylamidoalkyltrialkylammonium, trialkylbenzylammonium, trialkylhydroxyalkylammonium or alkylpyridinium chlorides or bromides; imidazoline derivatives; or amine oxides of cationic nature.

The above surfactants are generally present in an amount for each of between 0.01% and 20% by weight relative to the weight of the composition.

The dye composition in accordance with the invention may also contain various adjuvants conventionally used in compositions for dyeing the hair, such as anionic, cationic, nonionic, amphoteric or zwitterionic polymers or mixtures thereof, mineral or organic thickeners, and in particular anionic, cationic, nonionic and amphoteric polymeric associative thickeners, antioxidants, penetrating agents, sequestering agents, fragrances, buffers, dispersants, conditioners, for instance volatile or non-volatile, modified or unmodified silicones, film-forming agents, ceramides, preserving agents and opacifiers.

The above adjuvants are generally present in an amount for each of between 0.01% and 20% by weight relative to the weight of the composition.

Needless to say, a person skilled in the art will take care in selecting this or these optional additional compound(s) such that the advantageous properties intrinsically associated with the oxidation dye composition in accordance with the invention are not, or are not substantially, adversely affected by the envisaged addition(s).

The pH of the dye composition in accordance with the invention is generally between 3 and 12 approximately and preferably between 5 and 11 approximately. It may be adjusted to the desired value using acidifying or basifying agents usually used in the dyeing of keratin fibres, or alternatively using standard buffer systems.

Among the acidifying agents that may be mentioned, for example, are mineral or organic acids, for instance hydrochloric acid, orthophosphoric acid, sulphuric acid, carboxylic acids, for instance acetic acid, tartaric acid, citric acid and lactic acid, and sulphonic acids.

Among the basifying agents that may be mentioned, for example, are aqueous ammonia, alkaline carbonates, alkanolamines such as mono-, di- and triethanolamine, and derivatives thereof, sodium hydroxide, potassium hydroxide and the compounds of formula (II) below:

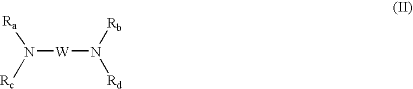

in which W is a propylene residue optionally substituted with a hydroxyl group or a C₁-C₄ alkyl radical; Rₐ, R_{b}, R_{c} and R_{d}, which may be identical or different, represent a hydrogen atom or a C₁-C₄ alkyl or C₁-C₄ hydroxyalkyl radical.

The composition may comprise at least one oxidizing agent. It is chosen more particularly from the oxidizing agents conventionally used in the field, for instance hydrogen peroxide, urea peroxide, alkali metal bromates, persalts such as perborates and persulphates, peracids and oxidase enzymes, among which mention may be made of peroxidases, 2-electron oxidoreductases such as uricases, and 4-electron oxygenases, for instance laccases. Hydrogen peroxide is particularly preferred.

The dye composition according to the invention may be in various forms, such as in the form of liquids, creams or gels, or in any other form that is suitable for dyeing keratin fibres and especially human hair.

The process of the invention is a process for dyeing keratin fibres in which the composition of the invention is applied to the keratin fibres for a time that is sufficient to obtain the desired colouration.

The leave-in time for the composition of the invention is generally between 3 and 50 minutes approximately and preferably 5 to 30 minutes approximately.

A subject of the invention is also the use of the 1H-pyrazolyl-ethenyl-indolium derivative for dyeing human keratin fibres such as the hair.

The examples that follow serve to illustrate the invention without, however, being limiting in nature.

### EXAMPLES

5×10⁻⁴ mol % of dye of formula DYE 1 is dissolved in a buffer solution at pH 9 (2 g of ammonium acetate in 40 ml of water adjusted to pH 9 by adding concentrated aqueous ammonia, made up to 100 ml with demineralized water). A lock of grey hair is immersed in the solution containing the dye (ratio of the amount of solution:amount of hair=10:1).

After 20 minutes, the hair is rinsed with demineralized water. The hair is thus dyed yellow.

The same process is performed with the dye DYE 2. The hair is thus dyed yellow, as previously.

1. Composition for dyeing human keratin fibres, comprising, in a suitable cosmetic medium, a 1H-pyrazolyl-ethenyl-indolium derivative of formula (I) below: 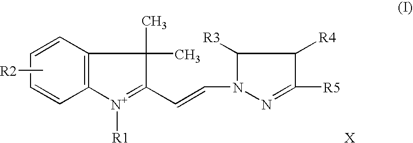
in which
R1 represents a linear or branched C1-C4 alkyl radical or a C1-C4 aralkyl radical,
R2 represents a hydrogen atom, a C1-C4 alkyl radical, a C1-C4 alkoxy radical, a halogen atom or a nitro group;
R3 and R4, which may be identical or different, represent a hydrogen atom, a C1-C4 alkyl radical, an aryl radical which may be substituted with one radical R chosen from a halogen atom, a hydroxyl radical, a C1-C4 alkyl radical, a C1-C4 alkoxy radical, a carboxyl radical and a trifluoromethyl radical,
R5 represents a hydrogen atom, a C1-C4 alkyl radical or an aryl radical that may be substituted with one radical R, and
X is a counterion.

2. Composition according to claim 1, in which R1 represents a C1-C4 alkyl radical.

3. Composition according to claim 1, in which R2 represents a hydrogen atom or an alkyl or alkoxy radical.

4. Composition according to claim 1 or 2, in which R2 represents a hydrogen atom or a methyl or methoxy radical.

5. Composition according to any one of the preceding claims, in which R3 and R4 represent a hydrogen atom or an alkyl or phenyl radical.

6. Composition according to claim 4, in which R3 represents a hydrogen atom, a methyl radical or a phenyl radical, which may be substituted with one or more hydroxyl, alkoxy, methyl or chloro radicals.

7. Composition according to claim 4, in which R4 represents a hydrogen atom or a methyl or phenyl radical, which may be substituted with one or more hydroxyl, alkoxy, methyl or chloro radicals.

8. Composition according to any one of the preceding claims, in which R5 represents a hydrogen atom, an alkyl radical or a phenyl radical, which may be substituted with one or more hydroxyl, alkoxy, methyl or chloro radicals.

9. Composition according to any one of the preceding claims, in which R1 represents a methyl radical, R2 represents a hydrogen atom, R4 represents a methyl radical and, when R5 represents 4-hydroxyphenyl, then R3 represents a methyl radical, when R5 represents a 4-methoxyphenyl radical, then R3 represents a hydrogen atom, when R5 represents a 2-hydroxyphenyl radical, then R3 represents a phenyl radical, or when R5 represents a 4-chlorophenyl radical, then R3 represents a 2-hydroxyphenyl radical.

10. Composition according to any one of the preceding claims, in which the derivative of formula (I) is chosen from:

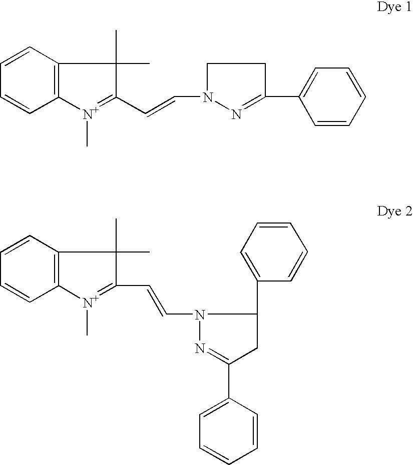

11. Composition according to any one of the preceding claims, comprising an amount of derivative of formula (I) of between 0.01% and 20% by weight relative to the total weight of the composition.

12. Composition according to any one of the preceding claims, also comprising a compound chosen from direct dyes, oxidation bases and couplers.

13. Composition according to any one of the preceding claims, comprising at least one oxidizing agent chosen from hydrogen peroxide, urea peroxide, alkali metal bromates, persalts, peracids and oxidase enzymes.

14. Composition according to any one of the preceding claims, comprising at least one anionic, cationic, nonionic, amphoteric or zwitterionic surfactant, or mixtures thereof.

15. Composition according to any one of the preceding claims, comprising at least one additive chosen from anionic, cationic, nonionic, amphoteric or zwitterionic polymers or mixtures thereof, mineral or organic thickeners, and in particular anionic, cationic, nonionic and amphoteric polymeric associative thickeners, antioxidants, penetrating agents, sequestering agents, fragrances, buffers, dispersants, conditioners volatile or non-volatile, modified or unmodified silicones, film-forming agents, ceramides, preserving agents and opacifiers.

16. Process for dyeing human keratin fibres, characterized in that it comprises the application to the keratin fibres of a composition as defined in any one of claims 1 to 15.

17. Use of a 1H-pyrazolyl-ethenyl-indolium derivative of formula (I) as defined in any one of claims 1 to 10, for dyeing human keratin fibres.
